(19) United States
(12) Patent Application Publication
(10) Pub. No.: US 2005/0212357 A1
(43) Pub. Date: Sep. 29, 2005

(54) Brake monitoring and sensor system for sensing temperature and wear

(76) Inventor: Frank Adams, Edison, NJ (US)

Correspondence Address: EZRA SUTTON, PA, PLAZA 9, 900 ROUTE 9, WOODBRIDGE, NJ, 07095, US

(21) Appl. No.: 10/806,686

(22) Filed: Mar. 23, 2004

(51) Int. Cl. B60T 8/88

(52) U.S. Cl. 303/122.03; 188/1.11 L

(57) ABSTRACT

A vehicle brake having a brake monitoring and sensor system attached to a brake shoe of a brake assembly for monitoring of temperature and wear of a brake shoe lining of a vehicle. The vehicle brake monitoring and sensor system includes a brake assembly for frictional braking of a vehicle. The brake assembly includes a brake shoe lining having a brake shoe and a brake pad for frictional engagement with the brake assembly; and the brake shoe lining has first rivet openings with rivets therein, and has second rivet openings with no rivets therein. The vehicle brake monitoring system also includes a sensor system having a first sensing element and a second sensing element each connected to the brake shoe; the first sensing element is embedded in one or more of the first rivet openings with the rivets therein; and the second sensing element is embedded in one or more of the second rivet openings having no rivets therein. The first sensing element is for generating a first electrical signal in response to sensing changes in the temperature of the brake shoe generated by heat in the brake shoe and transmitted to one or more rivets in the first rivet openings. The second sensing element is for generating a second electrical signal in response to sensing a predetermined depth of wear of the brake pad. The vehicle brake monitoring and sensor system further includes a monitoring unit for processing the first and second electrical signals generated by the first and second sensing elements.

### FIELD OF THE INVENTION

The present invention relates to a vehicle brake monitoring and sensor system for a braking assembly. More particularly, the vehicle brake monitoring and sensor system senses temperature and wear of the brake lining of the vehicle.

### BACKGROUND OF THE INVENTION

Brake lining wear detection systems are well known in the prior art. Further, temperture measurement systems are also well known in the prior art. However, present systems do not have the capability of detecting brake wear while detecting the operating temperature of the brake lining of a vehicle.

Drum brakes are widely used in vehicle braking systems. In a typical drum brake, two arcuate brake shoe assemblies are located inside a rotating cylindrical brake drum. Each brake shoe assembly includes a backing plate which carries brake lining friction material presenting a wear surface. A brake actuator moves the brake shoe assemblies toward the rotating brake drum such that the wear surface of the brake lining friction material contacts the inner surface of the drum, thus retarding the rotation of the drum. Over a period of time, the contact between the lining and the drum causes the lining to wear. If the lining becomes too thin, ineffective braking can occur. Thus, it is desirable to provide an indication when brake lining thickness is such that the brake shoes should be changed.

Several problems arise when trying to determine whether the brake linings have sufficiently worn such that they need to be changed. Often the wheel and the brake drum have to be removed from the vehicle for the brake lining thickness to be measured. This is cumbersome and time consuming. Visual brake lining wear indicators, such as notches in the lining or color coded layers in the lining, have been used more effectively to determine when the linings should be changed. When a visual wear indicator is used, an inspector can visually examine each brake lining to determine whether it needs to be changed without having to physically measure the thickness. However, the use of these visual wear indicators can also be cumbersome and time consuming because they require the inspector to visually check each lining while the vehicle is stationary. Thus, it is desirable to have an efficient way to continuously monitor the brake lining thickness during the operation of the vehicle to determine whether the brake linings need to be replaced without having to visually inspect each brake lining.

As larger-type of wheeled vehicles such as 8, 10 or 12 wheeled trucks have increased in size, weight and load carrying capacity it has become increasingly important for the truck driver to have an ongoing knowledge of the effectiveness of the braking system during the braking process. Additionally, the truck driver has a need for ongoing information/data on the state of readiness of all of the braking components/parts, particularly in terms of temperature and wear at all times during truck operation.

In a typical vehicle braking system, some type of function element such as a brake shoe in a drum system or a brake pad in a disc brake system is adapted to be moved against a rotating brake drum or disc brake rotor. Thus, there remains a need for a reliable method and device for measuring brake wear and monitoring brake temperature in either of the foregoing brake systems using simple temperature sensors and a simple monitoring/controller unit. It should be noted that the present invention is equally applicable to either drum brake systems or the disc brake systems.

Some prior art systems have monitored brake lining thickness on vehicles by using a single thermistor sensor in the lining which changes its electrical resistance based on temperature. Brake lining wear for this system is calculated based on changes in measured resistance of the thermistor. Such systems can often be ineffective and produce inaccurate results. Other systems have monitored the temperature of the brake linings to compare these temperatures to electronically stored standard characteristics for the brake lining. These systems are complicated and vary from lining to lining due to varying characteristics in lining materials and configurations. Other prior art monitoring systems have the wear sensors embedded and inserted within the brake pad, and as the brake pad wears out these wear sensors are destroyed in the process.

Thus, it is desirable to have a sensor system having a simple temperature indicator and lining wear indicator which can be used universally on all brake linings and which calculates accurately the remaining useful thickness of brake lining material.

### DESCRIPTION OF THE PRIOR ART

The use of different types of brake monitoring devices having various designs, configurations, structures and materials of construction are well known in the prior art. For example, U.S. Pat. No. 5,559,286 to WHITE et al. discloses a vehicle friction material condition measurement system. This system includes a sensor which responds to both changes in working length and temperature is embedded in a friction lining to provide a signal indicative of both wear and temperature to an electronic control unit which interprets long term averaged change in the sensor resistance measured when the vehicle is stationary as lining wear and short term changes in sensor resistance as representative of lining temperature. This prior art patent does not disclose or teach the brake monitoring and sensor system of the present invention.

U.S. Pat. No. 5,637,794 to HANISK discloses a resistive brake lining wear and temperature sensing system. This system includes a brake lining temperature and wear sensor having a plurality of serially connected wire loops and a resistive temperature sensor having a lower range of resistance than any one resistor mounted in a cavity formed in the brake lining where a plurality of resistors are connected one to each wire loop to be sequentially connected to a sensor circuit as the brake lining wears and breaks each wire loop. A control unit provides an electrical current to the sensor circuit and monitors the electrical potential across the plurality of wire loops and the resistive temperature sensor and then generating an output signal representing the temperature and wear of the brake lining. This prior art patent does not disclose or teach the brake monitoring and sensor system of the present invention.

U.S. Pat. No. 5,939,978 to KYRTSOS discloses a temperature sensing brake lining wear indicator. The brake lining wear indicator utilizes a temperature sensor assembly embedded in a brake lining of a drum brake assembly. The temperature sensor assembly includes two temperature sensors with a first temperature sensor located at a first distance X from the wear surface of the brake lining and a second temperature sensor located at a second distance X+d from the wear surface. A timing device measures the time period for the first temperature sensor to reach a first predetermined temperature and measures the time period for the second temperature sensor to reach a second predetermined temperature. Thus, the wear indicator provides a time-temperature based determination of when the brake linings should be replaced. This prior art patent does not disclose or teach the brake monitoring and sensor system of the present invention.

U.S. Pat. No. 4,824,260 to NOVOTNY et al. discloses a brake block temperature and wear measuring device. The device uses a thermocouple with a brake block having a frictional element with a friction face adapted to be moved into contact with the braking face of a brake drum which outputs a signal indicative alternatively of the steady state temperature of the brake block friction element and of the transient temperature of the friction element brake drum interface. This prior art patent does not disclose or teach the brake monitoring and sensor system of the present invention.

European Patent Number EP 1 081 404 A2 to RANCOURT discloses temperature sensors that provide temperature data with respect to the heat generated in the disc brake assembly (near the disc). For example, the sensor will measure the temperature of the housing wall next to the brake lining near the disc brake. The temperature sensors are used to measure the increase in temperature and also brake fading (breakdown in the brake pads/lining). This prior art reference does not disclose or teach the brake monitoring and sensor system of the present invention.

International Publication Number WO84/00406 to MICHAEL discloses a heat sensor mounted close to a disc in a disc brake assembly. The heat sensor will give a warning when the wheels are overheating. The heat sensor is used for measuring an increase in temperature for the disc brake. This prior art reference does not disclose or teach the brake monitoring and sensor system of the present invention.

None of these prior art patents teach or disclose the structure, design and configuration of a vehicle brake monitoring and sensor system that has a plurality of temperature and wear detector elements for the continuous monitoring of the temperature and wear of the brake shoe lining of the vehicle during operation as shown in the present invention.

Accordingly, it is an object of the present invention to provide a vehicle brake monitoring and sensor system for the monitoring of temperature and wear of the brake shoe lining of the vehicle using one or more thermal sensor elements and one or more wear sensor detector elements being detachably connected to the brake shoe lining of the brake drum system for each wheel of the vehicle.

Another object of the present invention is to provide a vehicle brake monitoring and sensor system that is easily serviceable having a low cost of installation for the vehicle and being easy to install for new or old vehicles, such as tractor trailers.

Another object of the present invention is to provide a sensor system having no moving parts and each sensor element can be easily maintained; and replaced as needed by the operator.

Another object of the present invention is to provide a vehicle brake monitoring and sensor system that gives more accurate heat readings as the thermal sensor elements are reading the heat generated on the rivet and brake shoe rather than on the brake pad of the brake drum system. This is because the brake pad is designed to dissipate the heat in the brake pad as soon as possible as the brake pad is in a cooling process and the thermal sensor elements receive a more accurate reading because the brake shoe takes longer to cool down than the brake pad. Also, the rivet is not thick and thus heats up quickly.

Another object of the present invention is to provide a vehicle brake monitoring and sensor system that has no inaccurate temperature and wear readings and has minimal maintenance problems when in operational use thereof.

Another object of the present invention is to provide a vehicle brake monitoring and sensor system having a control monitoring panel with a plurality of digital brake temperature gauges having a memory read-out that gives the highest temperature of operation during the vehicle trip.

Another object of the present invention is to provide a control monitoring panel that has a buzzer and wear indicator light indicating when the brake pad of the brake shoe lining has worn a predetermined distance and is sensed by the wear sensor detector elements of a given wheel.

A further object of the present invention is to provide a vehicle monitoring and sensor system that can be mass produced in an automated and economical manner and is readily affordable by the vehicle operator.

### SUMMARY OF THE INVENTION

In accordance with the present invention, there is provided a vehicle brake having a brake monitoring and sensor system attached to a brake shoe of a brake assembly for monitoring of temperature and wear of a brake shoe lining of a vehicle. The vehicle brake monitoring and sensor system includes a brake assembly for frictional braking of a vehicle. The brake assembly includes a brake shoe lining having a brake shoe and a brake pad for frictional engagement with the brake assembly; and the brake shoe lining has first rivet openings with rivets therein, and has second rivet openings with no rivets therein. The vehicle brake monitoring system also includes a sensor system having a first sensing element and a second sensing element each connected to the brake shoe; the first sensing element is embedded in one or more of the first rivet openings with the rivets therein; and the second sensing element is embedded in one or more of the second rivet openings having no rivets therein. The first sensing element is for generating a first electrical signal in response to sensing changes in the temperature of the brake shoe generated by heat in the brake shoe which is transmitted to one or more rivets in the first rivet openings. The second sensing element is for generating a second electrical signal in response to sensing a predetermined depth of wear of the brake pad. The vehicle brake monitoring and sensor system further includes a monitoring unit for processing the first and second electrical signals generated by the first and second sensing elements.

### BRIEF DESCRIPTION OF THE DRAWINGS

Further objects, features and advantages of the present invention will become apparent upon the consideration of the following detailed description of the presently-preferred embodiment when taken in conjunction with the accompanying drawings, wherein:

FIG. 1 is a perspective view of a brake monitoring and sensor system of the preferred embodiment of the present invention showing a thermal sensor element and a wear sensor detector element attached to a brake shoe of a brake drum system;

FIG. 2 is a perspective view of the brake monitoring and sensor system of the present invention showing a thermal sensor element;

FIG. 3 is an exploded perspective view of the brake monitoring and sensor system of the present invention showing the thermal sensor element being received within an opening of a sensor housing member;

FIG. 3A is a bottom perspective view of the brake monitoring and sensor system of the present invention showing the thermal sensor element disposed within the opening of the sensor housing member;

FIG. 4 is a cross-sectional view of the brake monitoring and sensor system of the present invention taken along lines 4-4 of FIG. 1 in the direction of the arrows showing the thermal sensor element attached to the rivet of a lower brake shoe;

FIG. 5 is an exploded perspective view of the brake monitoring and sensor system of the present invention showing the major component parts of the brake shoe of the brake drum system having the sensor elements attached thereto;

FIG. 6 is a perspective view of the brake monitoring and sensor system of the present invention showing an air can assembly of the brake drum system;

FIG. 7 is a perspective view of the brake monitoring and sensor system of the present invention showing the wear sensor detector element having a brass contact member and a pair of contact points thereon;

FIG. 8 is a cross-sectional view of the brake monitoring and sensor system of the present invention taken along lines 8-8 of FIG. 1 in the direction of the arrows showing the major component parts of the wear sensor detector element;

FIG. 9 is a schematic representation of the brake monitoring and sensor system of the present invention showing the placement of the sensor elements on each set of paired wheels of a tractor trailer being connected to a control monitor panel;

FIG. 10 is a schematic representation of the brake monitoring and sensor system of the present invention showing the control monitor panel having a plurality of digital brake temperature gauges; and a plurality of wear indicator buzzers and wear sensor indicator lights thereon; and

FIG. 11 is schematic representation of the brake monitoring and sensor system of the present invention showing the sensor elements connected to a plurality of rivets of the brake shoe and sensor connections attached to the dashboard monitor.

### DETAILED DESCRIPTION OF THE PREFERRED EMBODIMENT

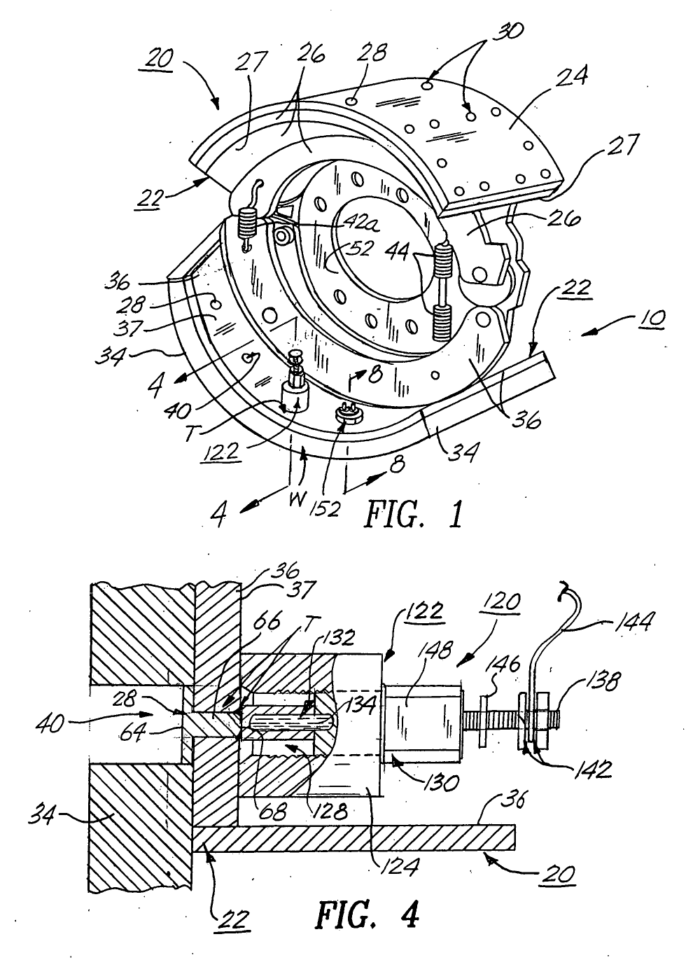

The brake monitoring and sensor system 10 and its component parts of the preferred embodiment of the present invention are represented in detail by FIGS. 1 through 11 of the patent drawings. The brake monitoring and sensor system 10 is used for the monitoring of temperature T and wear W of a brake shoe lining 22 of a brake drum system 20, as shown in FIGS. 1, 4, 5 and 11 of the drawings. The monitoring and sensor system 10 includes a control monitoring panel 100 on a dashboard 12 of a cab section 14 of a tractor trailer 16 and a trailer section 16t having a plurality of sets of paired wheels 18a, 18b, 18c, 18d, 18e, 18f, 18g and 18h on the trailer section 16t and a pair of standard wheels 18i and 18j on the cab section 14 of the tractor trailer 16. The monitoring and sensor system 10 also includes a sensor system assembly 120 having at least one or more thermal sensor elements 122 detachably connected to the brake shoe lining 22 of the brake drum system 20 and having at least one or more wear sensor detector elements 152 detachably connected to the brake shoe lining 22 of the brake drum system.

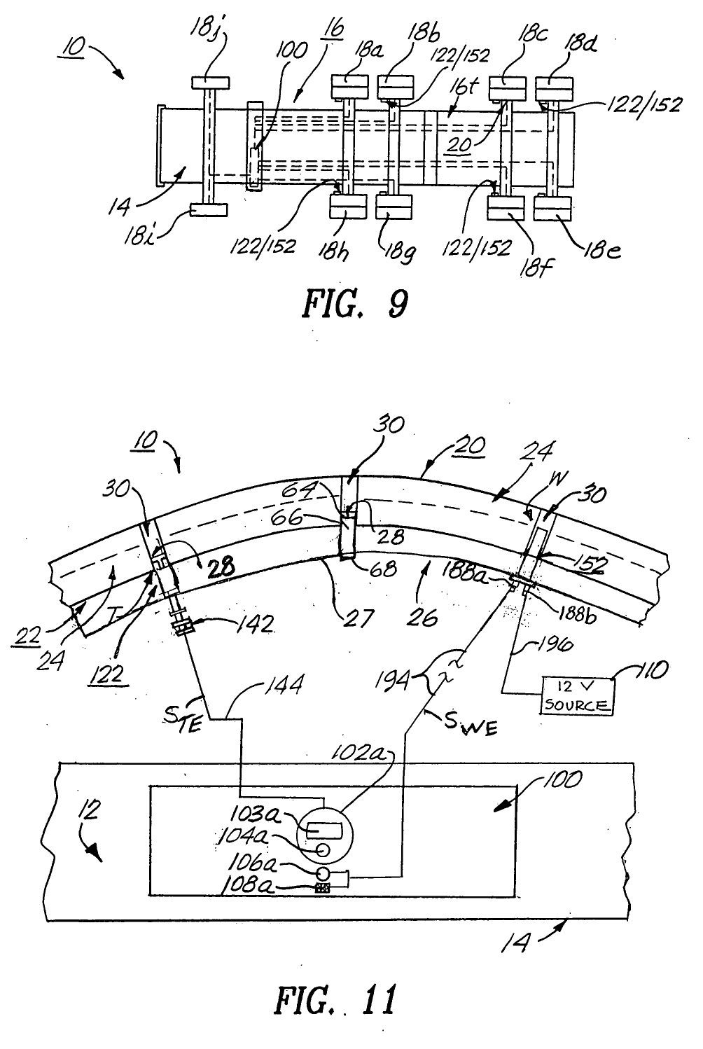

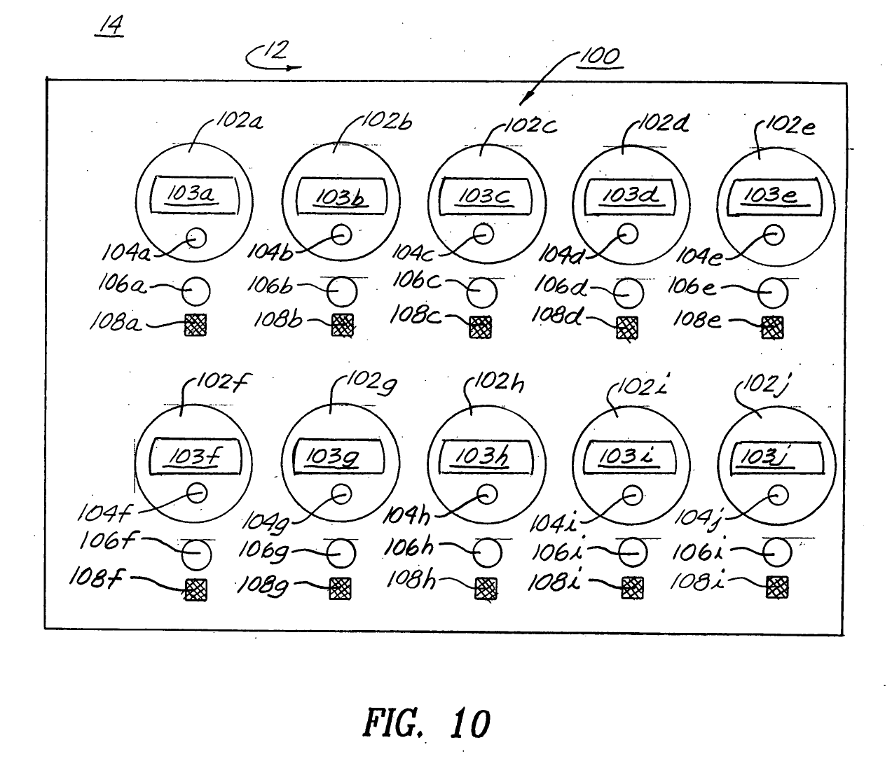

As shown in FIG. 9, the monitoring and sensor system 10 depicts the placement of the thermal sensor elements 122 and the wear sensor detector elements 152 on each set of paired wheels 18a to 18h of the trailer section 16t of the tractor trailer 16 as well as on the wheels 18i and 18j of the cab section 14 of the tractor trailer 16. The thermal sensor elements 122, as well as the wear sensor detector elements 152, are electronically connected to the control monitoring panel 100 on the dash board 12 of cab section 14 of tractor trailer 16, as shown in FIGS. 10 and 11 of the drawings. The control monitoring panel 100 includes a plurality of digital brake temperature gauges 102a, 102b, 102c, 102d, 102e, 102f, 102g, 102h, 102i and 102j. Each of the brake temperature gauges 102a to 102j includes a digital readout panel 103a, 103b, 103c, 103d, 103e, 103f, 103g, 103h, 103i and 103j and a reset button 104a, 104b, 104c, 104d, 104e, 104f, 104g, 104h, 104i and 104j thereon. The control monitoring panel 100 further includes a wear indicator light 106a, 106b, 106c, 106d, 106e, 106f, 106g, 106h, 106i and 106j for indicating brake wear on a particular set of paired wheels 18a to 18h of the trailer section 16t and/or on the wheels 18i and 18j of the cab section 14 of the tractor trailer 16. The control monitoring panel 100 additionally includes a wear indicator buzzer 108a, 108b, 108c, 108d, 108e, 108f, 108g, 108h, 108i and 108j for indicating brake wear also on a particular set of paired wheels 18a to 18h of the trailer section 16t and/or on the wheels 18i and 18j of the cab section 14 of the tractor trailer 16. Each of the brake temperature gauges 102a to 102h are electrically connected to a thermal sensor element 122 via an electrical wire 144, as shown in FIG. 11 of the drawings. Each of the wear indicator lights 106a to 106j and wear indicator buzzers 108a to 108j are electrically connected (in series) to a wear sensor detector element 152 via an electrical wire 194, as shown in FIG. 11 of the drawings, for giving a visual and auditory alarm to an operator when the brake shoe lining 22 of the brake drum assembly 20 has worn and is failing.

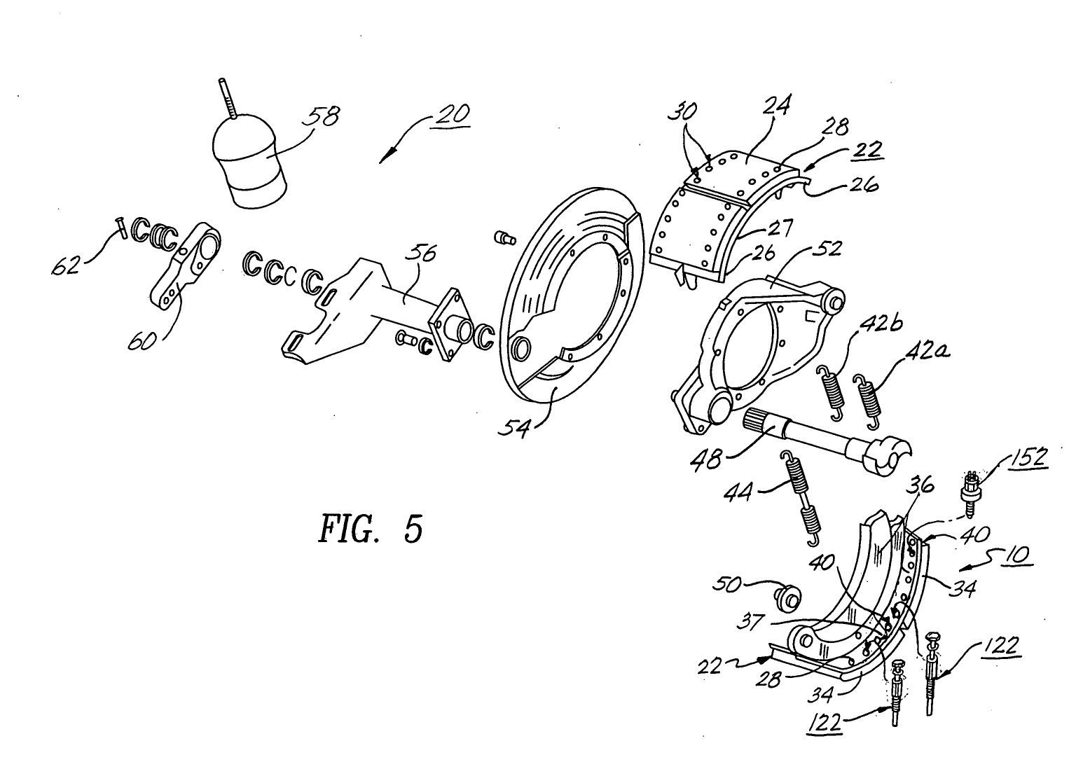

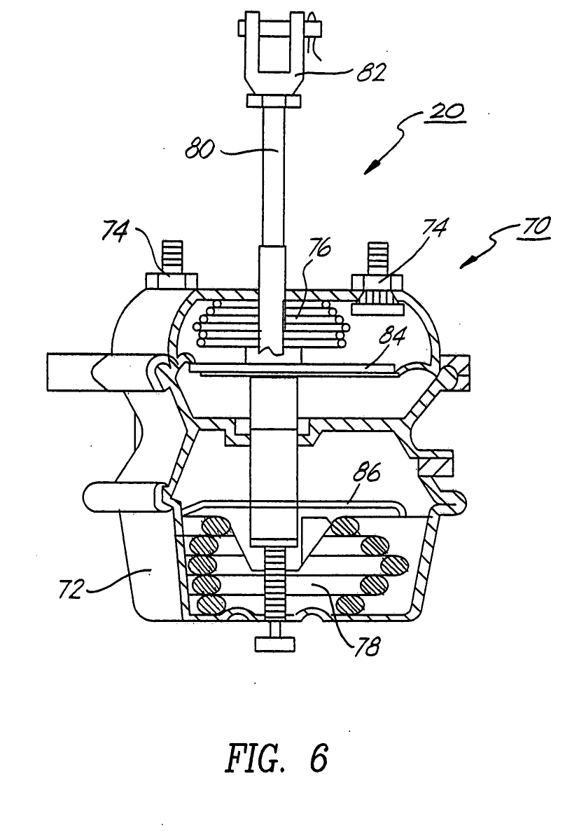

As shown in FIGS. 1 and 5, the standard brake drum system 20 includes a brake shoe lining 22 having an upper brake pad 24 attached to an upper brake shoe 26 having an inner brake shoe surface 27 by a plurality of rivets 28 within rivet openings 30, and having a lower brake pad 34 attached to a lower brake shoe 36 having an inner brake shoe surface 37 by the plurality of rivets 28 within rivet openings 40. The brake drum system 20 also includes a pair of mounting springs 42a and 42b for holding each of the upper and lower brake shoes 26 and 36 together, a return spring 44, a spline shaft 46 for an S-cam 48, an S-cam roller 50 and a spider housing 52. The brake drum system 20 further includes a dust cover 54, a mounting bracket 56 for an air can 58, a slack adjuster 60 and a slack adjuster clevis pin 62. Each of the rivets 28 include a rivet head 64 and a rivet stem 66 having a rivet end 68. As shown in FIG. 6, the standard brake drum system 20, additionally includes an air can assembly 70 having an air can housing 72 with mounting studs 74 attached thereto. The air can assembly 70 further includes an inner spring 76, an outer spring 78, an air can shaft 80 having a slack adjuster clevis pin 82 attached thereto and inner and outer diaphragm members 84 and 86 within the air can housing 72.

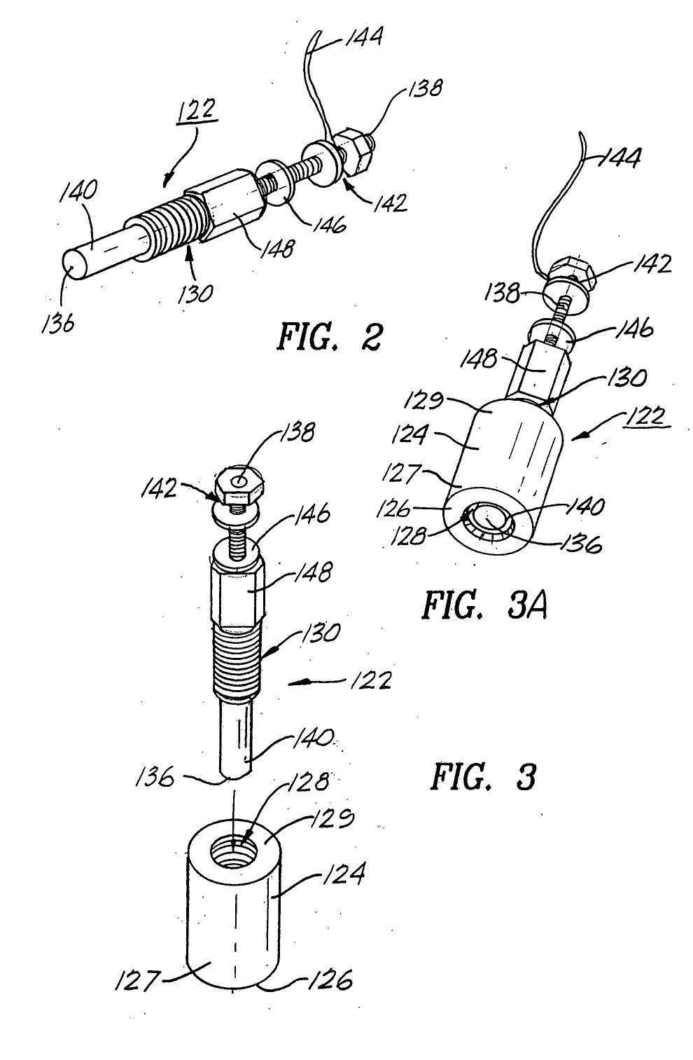

As shown in FIGS. 1, 4, 5 and 11, the thermal sensor element 122 of sensor system assembly 120 includes a sensor housing member 124 having a bottom wall 126 at one end 127, and a sensor mounting opening 128 at the other end 129 thereof for receiving a threaded sensor sleeve 130 therein. The threaded sensor sleeve 130, as shown in FIGS. 2 and 3, includes a hollow sensor compartment 132 for receiving thermal sensor oil 134 therein and having a flat end tip 136 thereon. The threaded sensor sleeve 130 also includes a proximal end 138 and a distal end 140. The proximal end 138 of thermal sensor sleeve 130 includes an attachment section 142 for receiving an electrical wire 144 and a circular stop tab 146 thereon. The threaded sensor sleeve 130 further includes an integrally attached adjustment hex nut 148 for adjusting the flat end tip 136 of the thermal sensor member 134 to be in contact with the rivet end 68 of the rivet stem 66 of rivet 28 within the rivet opening 40 of the lower brake shoe 36 of brake shoe lining 22, as depicted in FIGS. 1 and 4 of the drawings. Additionally, the bottom wall 126 of housing member 124 is fixedly attached to the inner brake shoe surface 27 and/or 37 of the brake shoe 26 and/or 36 via welding, laser welding or the like.

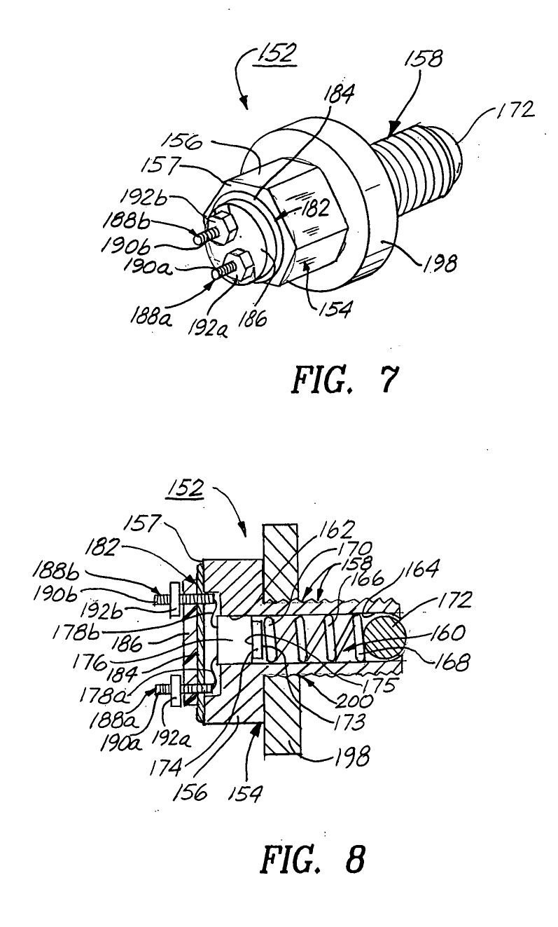

As shown in FIGS. 7, 8 and 11, the wear sensor detector element 152 of sensor system assembly 120 includes a wear sensor housing member 154 having a mounting head 156 and a threaded shaft 158 with a shaft opening 160 therein. Mounting head 156 includes an outer wall surface 157. Shaft opening 160 includes a proximal end 162 and a distal end 164. The shaft opening 160 is used for receiving a compressible spring 166 having a first end 168 and a second end 170 and a sensor tip ball 172 in contact and adjacent to the first end 168 of compressible spring 166. The distal end 164 of shaft opening 160 of threaded shaft 158 is for slidably receiving the sensor tip ball 172 therein, as shown in FIGS. 7 and 8 of the drawings. The proximal end 162 of shaft opening 160 is for receiving a contact pad 174 and a switch member 176 therein. One side 173 of contact pad 174 is in contact with and adjacent to the second end 170 of compressible spring 166 and the other side 175 of contact pad 174 is in contact with and adjacent to switch member 176. Switch member 176 includes a pair of electrical leads 178a and 178b attached to an upper wall surface 180 of switch member 176, as shown in FIG. 8 of the drawings. The outer wall surface 157 of mounting head 156 includes an electrical contact member 182 having a contact base section 184, and a contact pad section 186 with a pair of spaced-apart electrical contact holding lead elements 188a and 188b thereon. Each of the holding lead element 188a and 188b include a threaded stem 190a and 190b and a hex nut 192a and 192b, respectively, thereon, as depicted in FIGS. 7 and 8 of the drawings. The threaded shaft 158 of the wear sensor detector element 152 is received within (tapped in) rivet opening 30 or 40 of the upper or lower brake pads 24 or 34, respectively, as depicted in FIG. 11 of the drawings. Each of the threaded stems 190a and 190b of the holding lead elements 188a and 188b include a first electrical wire 194 and a second electrical wire 196, respectively, thereon. The first electrical wires 194 connect the wear indicator lights and buzzers 106a to 106j and 108a to 108j (in series) of the wear sensor detector elements 152 to the control monitoring panel 100, as depicted in FIG. 11. The second electrical wires 196 are electrically connected to a 12 volt power source 110 for powering of the wear sensor detector elements 152, as shown in FIG. 11. The threaded shaft 158 of the wear sensor housing member 154 of wear sensor detector element 152 also includes a detachable spacer 198 having a spacer opening 200 for receiving the threaded shaft 158 therethrough. Spacer 198 is in contact with and adjacent to the mounting head 156 and the inner brake shoe surfaces 27 and 37 of brake shoes 26 and 36, respectively, as shown in FIGS. 1 and 11 of the drawings, for adjusting the wear sensor detector elements 152 to a predetermined depth of wear for brake pads 24 or 34, respectively.

### Operation of the Present Invention

Upon installation of the thermal and wear sensor elements 122 and 152 on the brake shoe lining 22 of the brake drum system 20, as previously described above, the brake monitoring and sensor system 10 operates in the following manner, as shown in FIGS. 1, 4, and 9 through 11 of the patent drawings. As a driver operates a moving vehicle, such as a tractor trailer 16 as depicted in FIG. 9, a control monitoring panel 100 on the dashboard 12 of the cab section 14 of the tractor trailer 16 is constantly monitoring the temperature T and wear W of a brake shoe lining 22 of a brake drum system 20 for any one of the paired sets of wheels 18a to 18h on the trailer section 16t and/or on the wheels 18i and 18j on the cab section 14 of the tractor trailer 16, respectively.

As a particular brake pad 24 or 34 of a brake shoe 26 or 36 wears in the operation of tractor trailer 16, the control monitoring panel 100 via the thermal sensor element 122 and the wear sensor detector element 152 of sensor system 120 give the operator a visual, as well as a sound (buzzer) readings of temperature T and wear W by the use of the digital brake temperature gauges 102a to 102j and by the use of the indicator lights or buzzer indicators 106a to 106j and 108a to 108j, respectively, for detecting abnormal temperature T or wear W of a particular brake pad 24 or 34 of brake shoe 26 or 36 on a particular paired wheel set 18a to 18h or wheel 18i and 18j, respectively.

When the digital brake temperature gauge 102a to 102j reaches a temperature range of at least 350 to 400° F. for a particular set of wheels 18a to 18j, then the vehicle operator knows to check that brake drum assembly 20 for that wheel 18a to 18j for damage, problems and the like. At ambient temperature an ambient reference electrical signal is generated. If the brake drum assembly 20 is not in electrical contact with the brake pad 24 and/or 34, then the electrical signal S_{TE} generated does not increase above the ambient reference electrical signal. Thus, if there is no heat reading (lack of heat) being generated by the one or more thermal sensor elements 122 for a particular set of wheels 18a to 18h or on wheels 18i and 18j on the control monitoring panel 100, this means that the brake drum assembly 20 is inoperative and not working. Such problems and/or damage to the brake drum assembly 20 includes the following components: air valves to the air cans 58, air cans 58, broken air lines, diaphragms 84 or 86, drum shaft 80, springs 76 or 78, slack adjuster 60, slack adjuster clevis pin 82, mounting bracket 56 for the air can 58, S-can 48, S-can roller 50, spline shaft 56 for the S-can 48, return spring 44, as well as the brake shoe lining 22, as shown in FIGS. 5 and 6 of the drawings. Thus, the digital brake temperature gauges 102a to 102j give the vehicle operator a “heads-up” when a problem/damage occurs to the brake drum assembly 20 by giving an accurate temperature reading T for that paired set of wheels 18a to 18h or wheels 18i and 18j. In the course of operation of the tractor trailer 16, the digital brake temperature gauges 102a to 102j have a memory read-out function that gives the vehicle operator the highest operating temperature T during the vehicle trip for each of the wheels 18a to 18j of the tractor trailer 16, as shown in FIGS. 9 and 10 of the drawings.

In the course of operating the tractor trailer 16, the brake shoe lining 22 of brake drum assembly 20 eventually wears for a particular pair set of wheels 18a to 18h for the trailer section 18t and/or for the wheels 18i and 18j for the cab section 14 of the tractor trailer 16, such that the control monitoring panel 100 gives both a visual and a sound warning that a particular brake shoe lining 22 is failing via the wear indicator lights and buzzers 106 to 106j and 108a to 108j, respectively. As the brake pad 24 and/or 34 of the brake shoe 26 and/or 36 is worn down, the wear sensor detector elements 152 within the empty rivet openings 30a and/or 40a are actuated as the sensor tip ball 172 has been contacted. Then the compressible spring 166 makes contact with the contact pad 174 and switch member 176. Switch member 176 then sends an electrical signal SWE via the electrical lead line 194 which in turn lights the indicator lights 106a to 106j, as well as buzzes the wear indicator buzzers 108a to 108j of a worn brake shoe lining 22 for a particular set of wheels 18a to 18h or wheels 18i and 18j for the tractor trailer 16, as shown in FIGS. 9 through 11 of the drawings.

### Advantages of the Present Invention

Accordingly, an advantage of the present invention is that it provides for a vehicle monitoring and sensor system for the monitoring of temperature and wear of the brake shoe lining of the vehicle using one or more thermal sensor elements and one or more wear sensor detector elements being detachably connected to the brake shoe lining of the brake drum system for each wheel of the vehicle.

Another advantage of the present invention is that it provides for a vehicle monitoring and sensor system that is easily serviceable having a low cost of installation for the vehicle and being easy to install for new or old vehicles, such as tractor trailers.

Another advantage of the present invention is that it provides for a sensor system having no moving parts and can be easily maintained; replaced as needed by the operator.

Another advantage of the present invention is that it provides for a vehicle monitoring and sensor system that gives more accurate heat readings as the thermal sensor elements are reading the heat generated on the rivet and brake shoe rather than on the brake pad of the brake drum system. This is because the brake pad is designed to dissipate the heat in the brake pad as soon as possible as the brake pad is in a cooling process and the thermal sensor elements receive a more accurate reading because the brake shoe takes longer to cool down than the brake pad. Also, the rivet is not thick and heats up quickly.

Another advantage of the present invention is that it provides for a vehicle monitoring and sensor system that has no inaccurate temperature and wear readings and has minimal maintenance problems when in operational use thereof.

Another advantage of the present invention is that it provides for a vehicle monitoring and sensor system having a control monitoring panel with a plurality of digital brake temperature gauges having a memory read-out that gives the highest temperature of operation during the vehicle trip.

Another advantage of the present invention is that it provides for a control monitoring panel that has a buzzer and wear indicator light indicating when the brake pad of the brake shoe lining has worn a predetermined distance and is sensed by the wear sensor detector elements of a given wheel.

Another advantage of the present invention is that it provides for a control monitoring panel to indicate a worn brake pad prior to the driving of the vehicle, such that the operator can arrange for the repair of the brake pad.

A further advantage of the present invention is that it provides for a vehicle monitoring and sensor system that can be mass produced in an automated and economical manner and is readily affordable by the vehicle operator.

A latitude of modification, change, and substitution is intended in the foregoing disclosure, and in some instances, some features of the invention will be employed without a corresponding use of other features. Accordingly, it is appropriate that the appended claims be construed broadly and in a manner consistent with the spirit and scope of the invention herein.

1. A vehicle brake having a brake monitoring and sensor system attached to a brake shoe of a brake assembly; comprising:
a) a brake assembly for frictional braking of a vehicle;
b) said brake assembly including a brake shoe lining having a brake shoe and a brake pad for frictional engagement with said brake assembly; said brake shoe lining having first rivet openings with rivets therein, and having second rivet openings with no rivets therein;
c) a sensor system having a first sensing element and a second sensing element each being connected to said brake shoe; said first sensing element being embedded in one or more of said first rivet openings with said rivets therein; said second sensing element being embedded in one or more of said second rivet openings having no rivets therein;
d) said first sensing element for generating a first electrical signal in response to sensing changes in the temperature of said brake shoe generated by heat in said brake shoe, said heat being transmitted to one or more rivets in said first rivet openings;
e) said second sensing element for generating a second electrical signal in response to sensing a predetermined depth of wear of said brake pad; and
f) a monitoring unit for processing said first and second electrical signals generated by said first and second sensing elements.

2. A vehicle brake monitoring and sensor system in accordance with claim 1, wherein said first sensing element is a thermal sensor element.

3. A vehicle brake monitoring and sensor system in accordance with claim 2, wherein said thermal sensor element includes a sensor housing member having a bottom wall at one end and a sensor threaded opening therethrough at the other end.

4. A vehicle brake monitoring and sensor system in accordance with claim 3, wherein said sensor mounting opening is for receiving a threaded sensor sleeve.

5. A vehicle brake monitoring and sensor system in accordance with claim 4, wherein said threaded sensor sleeve includes a flat tip end thereon.

6. A vehicle brake monitoring and sensor system in accordance with claim 5, wherein said threaded sensor sleeve includes a proximal end and a distal end, said proximal end includes an attachment section for receiving a first electrical lead wire for generating said continuous first electrical signal in response to changes in the temperature of said rivets and said brake shoe.

7. A vehicle brake monitoring and sensor system in accordance with claim 5, wherein said threaded sensor sleeve further includes an adjustment hex nut for adjusting said flat tip end of said threaded sensor sleeve within said opening of said sensor housing member in order to be in contact with said rivet within said first rivet openings of said brake shoe lining for measuring the changes in the temperature of said rivets and said brake shoe.

8. A vehicle brake monitoring and sensor system in accordance with claim 1, wherein said second sensing element is a wear sensor detector element.

9. A vehicle brake monitoring and sensor system in accordance with claim 8, wherein said wear sensor detector element includes a wear sensor housing member having a mounting head and a shaft with a shaft opening therein.

10. A vehicle brake monitoring and sensor system in accordance with claim 9, wherein said shaft opening includes a proximal end and a distal end.

11. A vehicle brake monitoring and sensor system in accordance with claim 9, wherein said shaft opening is used for receiving a compressible spring having a first end and a second end and a sensor tip ball in contact and adjacent to said first end of said compressible spring.

12. A vehicle brake monitoring and sensor system in accordance with claim 10, wherein said proximal end of said shaft opening is for slidably receiving said sensor tip ball therein.

13. A vehicle brake monitoring and sensor system in accordance with claim 10, wherein said distal end of said shaft opening is for receiving a contact pad and a switch member therein, such that one side of said contact pad is in contact with and adjacent to said second end of said compressible spring and the other side of said contact pad is in contact with and adjacent to said switch member.

14. A vehicle brake monitoring and sensor system in accordance with claim 13, wherein said switch member includes a pair of electrical leads attached to said switch member.

15. A vehicle brake monitoring and sensor system in accordance with claim 9, wherein said mounting head includes a surface having an electrical contact member with a contact base section and a contact pad section thereon.

16. A vehicle brake monitoring and sensor system in accordance with claim 15, wherein said contact pad section includes a pair of electrical contact lead elements thereon.

17. A vehicle brake monitoring and sensor system in accordance with claim 16, wherein each of said lead elements include a threaded stem and a hex nut, respectively, thereon.

18. A vehicle brake monitoring and sensor system in accordance with claim 9, wherein said shaft of said wear sensor detector element is received within said second rivet openings of said brake pad of said brake shoe lining.

19. A vehicle brake monitoring and sensor system in accordance with claim 17, wherein each of said stems of said lead elements includes a second electrical lead wire and a third electrical lead wire, said second electrical lead wire for generating said second electrical signal in response to the wearing out of said brake pad of said brake shoe lining.

20. A vehicle brake monitoring and sensor system in accordance with claim 19, wherein said third electrical lead is electrically connected to a power source for powering said wear sensor detector element.

21. A vehicle brake monitoring and sensor system in accordance with claim 1, wherein said monitoring unit includes a plurality of digital brake temperature gauges having a reset button thereon.

22. A vehicle brake monitoring and sensor system in accordance with claim 21, wherein said first electrical signal from said thermal sensor element gives a temperature reading of said rivet within said brake shoe of said brake shoe lining for viewing on said digital brake temperature gauge by an operator.

23. A vehicle brake monitoring and sensor system in accordance with claim 1, wherein said monitoring unit includes a plurality of wear indicator lights and a plurality of wear indicator buzzers, respectively, thereon and being in series.

24. A vehicle brake monitoring and sensor system in accordance with claim 23, wherein said second electrical signal from said wear sensor detector element provides a visual and auditory alarm to an operator from said wear indicator light and said wear indicator buzzer, respectively, when the wearing away of said brake pad of said brake shoe lining occurs.

25. A vehicle brake monitoring and sensor system in accordance with claim 24, wherein said brake pads are worn away at said predetermined depth of wear of at least ⅛ of an inch above the rivet head of said rivets within said brake pad of said brake shoe lining in order to allow said visual and auditory alarm to take place on said monitoring unit.

26. A vehicle brake monitoring and sensor system in accordance with claim 9, wherein said shaft of said wear sensor detector element further includes a detachable spacer having a spacer opening therethrough in order to adjust for said predetermined depth of wear.

27. A vehicle brake monitoring and sensor system in accordance with claim 26, wherein said spacer is in contact with and adjacent to said mounting head of said wear sensor detector element and inner brake shoe surfaces of said brake shoes fo adjusting said predetermined depth of wear of said sensor detector elements within said brake shoes.

28. A vehicle brake monitoring and sensor system in accordance with claim 1, wherein said first sensing element for generating no electrical signal when said brake assembly is not in contact with said brake pad.

29. A method of monitoring the temperature and wear of a brake shoe lining of a brake assembly, the brake assembly includes a brake shoe lining having a brake shoe and a brake pad for frictional engagement with the brake assembly; the brake shoe lining has first rivet openings with rivets therein, and has second rivet openings with no rivets therein; a sensor system having a first sensing element and a second sensing element each being connected to the brake shoe; and a monitoring unit for detecting the temperature and wear of the brake shoe lining, comprising the steps of:
a) embedding said first sensing element in one or more of said first rivet openings with said rivets therein;
b) embedding said second sensing element in one or more of said second rivet openings having no rivets therein;
c) actuating by an operator said brake assembly on said brake shoe lining for frictional braking of a vehicle;
d) generating a first electrical signal from said first sensing element;
e) sensing changes in the temperature of said brake shoe generated by heat on said brake shoe;
f) transmitting said first electrical signal from one or more rivets in said first rivet openings from heat generated by said rivets and said brake shoe to said monitoring unit;
g) generating a second electrical signal from said second sensing element;
h) sensing a predetermined depth of wear of said brake pad;
I) transmitting said second electrical signal in response to said sensing of said predetermined depth of wear of said brake pad to said monitoring unit; and
j) processing said first and second electrical signals generated by said first and second sensing elements for displaying a visual and an auditory alarm to the operator on said monitoring unit.

30. A method of monitoring in accordance with claim 29 further including the step of:
a) placing said second sensing element at said predetermined depth of wear of at least ⅛ of an inch above the rivet head of said rivets within said brake pad of said brake shoe lining in order to allow said visual and said auditory alarm to take place on said monitoring unit.
